(19) United States
(12) Patent Application Publication
(10) Pub. No.: US 2023/0351481 A1
(43) Pub. Date: Nov. 2, 2023

(54) WORKFLOWS FOR OFFSITE DATA ENGINE

(71) Applicant: Content Square SAS, Paris (FR)

(72) Inventors: Filipe Posteral, Paris (FR); Lionel Ngo, Paris (FR); Arthur Naegely, Paris (FR)

(21) Appl. No.: 17/733,015

(22) Filed: Apr. 29, 2022

(51) Int. Cl. G06Q 30/06; G06F 16/215; G06F 16/955; G06F 9/54

(52) U.S. Cl. CPC G06Q 30/0641; G06F 9/547; G06F 16/215; G06F 16/955

(57) ABSTRACT

Systems and techniques may be used for obtaining metadata related to a product. For example, a technique may include initiating an API call to trigger a scraper to scrape a URL to obtain metadata related to the product, which is displayed on a website corresponding to the URL. The technique may include saving the metadata. The technique may include receiving a request for information corresponding to the product, and exporting a portion of the metadata related to the request.

### BACKGROUND

Web commerce has become a nearly universal way to sell products. Managing web commerce websites is often done by a team of people, who use web analytics to make design, structural, and interactive choices for the web commerce websites. Sales data from a website may be used to determine whether a product is successful. However, the sales data does not tell the entire story, nor does it provide sufficient data to make proactive decisions.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some nonlimiting examples are illustrated in the figures of the accompanying drawings in which:

FIG. 1 is a diagrammatic representation of a networked environment in which the present disclosure may be deployed, in accordance with some examples.

FIG. 2 is a diagrammatic representation of an experience analytics system, in accordance with some examples, that has both client-side and server-side functionality.

FIG. 3 is a diagrammatic representation of a data structure as maintained in a database, in accordance with some examples.

FIG. 4 is a flowchart for a process, in accordance with some examples.

FIG. 5 is a diagrammatic representation of a machine in the form of a computer system within which a set of instructions may be executed for causing the machine to perform any one or more of the methodologies discussed herein, in accordance with some examples.

FIG. 6 is a block diagram showing a software architecture within which examples may be implemented.

FIG. 7 illustrates an example user website, in accordance with some examples.

FIG. 8 illustrates an example client website, in accordance with some examples.

FIGS. 9-10 illustrate example flow diagrams, in accordance with some examples.

FIG. 11 illustrates an example schematic diagram, in accordance with some examples.

### DETAILED DESCRIPTION

Systems and techniques described herein provide for obtaining product metadata related to a competitor website. A client may wish to know more information about a product displayed on competitor websites, such as price, discount, display location, or the like. However, there are two technical problems that arise in trying to obtain this data. First, a client may not know a Uniform Resource Locator (URL) corresponding to a competitor website that includes the product. The client may not know whether a competitor website even sells a particular product. Additionally, the URL with the product may change over time. To solve this technical problem, a technological solution includes using a scraper that can determine which URLs correspond to the product. Second, even after the URLs are known, a technical problem arises in how to capture metadata related to the product on the URLs, especially as the number of tracked products and corresponding URLs increases. In some examples, thousands of products may be tracked with tens or hundreds of thousands of corresponding URLs. The technological solution to this problem uses a second scraper to access each URL according to a schedule or on demand. As the second scraper obtains the metadata for a product, the metadata may be stored, for example in a database. This information may be accessed or output according to a client request.

Another technical problem arises in how to coordinate the scrapers, data management, and client requests. The systems and techniques described herein provide a solution to the coordination problem as well. This solution may include using an application programming interface (API) call to initiate a scraper, centrally storing metadata received, or using a task queue to orchestrate various components.

In some examples, competitive data for a product may be provided to a client. Competitive data may include competitive offers scraped from various marketplaces or price aggregators (e.g., online marketplace or shopping search engines or aggregators). Various information may be scraped and saved, such as a name of a reseller, a price, a product name, or the like. In order to scrape data corresponding to a product, a list of items (e.g., a Global Trade Item Number (GTIN) list) may be provided for tracking. A client may optionally provide an associated market (e.g., France, EU, US, North America, etc.). A scraper may be specific to a merchant, marketplace, website, etc. (e.g., a competitor website).

A component may be used to handle collection of the competitive data. In some examples disclosed herein, the component may be called a New Offsite Data Engine (NODE). The component may include multiple parts, such as a task queue or an API. The task queue may be used to orchestrate tasks that are used to get the competitive data. The task queue may interact with scrapers. The API part may allow for communication between the task queue and other parts or components that request or obtain competitive data.

### Networked Computing Environment

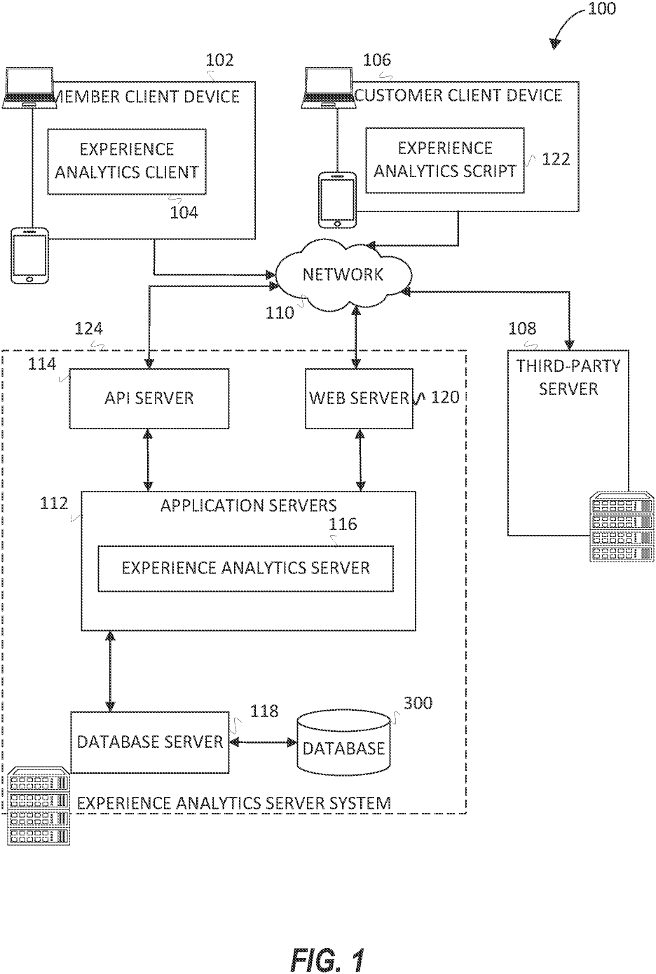

FIG. 1 is a block diagram showing an example experience analytics system 100 that analyzes and quantifies the user experience of users navigating a client’s website, mobile websites, and applications. The experience analytics system 100 can include multiple instances of a member client device 102, multiple instances of a customer client device 106, and multiple instances of a third-party server 108.

The member client device 102 is associated with a client of the experience analytics system 100, where the client that has a website hosted on the client’s third-party server 108. For example, the client can be a retail store that has an online retail website that is hosted on a third-party server 108. An agent of the client (e.g., a web administrator, an employee, etc.) can be the user of the member client device 102.

Each of the member client devices 102 hosts a number of applications, including an experience analytics client 104. Each experience analytics client 104 is communicatively coupled with an experience analytics server system 124 and third-party servers 108 via a network 110 (e.g., the Internet). An experience analytics client 104 can also communicate with locally-hosted applications using Applications Program Interfaces (APIs).

The member client devices 102 and the customer client devices 106 can also host a number of applications including Internet browsing applications (e.g., Chrome, Safari, etc.). The experience analytics client 104 can also be implemented as a platform that is accessed by the member client device 102 via an Internet browsing application or implemented as an extension on the Internet browsing application.

Users of the customer client device 106 can access client’s websites that are hosted on the third-party servers 108 via the network 110 using the Internet browsing applications. For example, the users of the customer client device 106 can navigate to a client’s online retail website to purchase goods or services from the website. While the user of the customer client device 106 is navigating the client’s website on an Internet browsing application, the Internet browsing application on the customer client device 106 can also execute a client-side script (e.g., JavaScript (.*js)) such as an experience analytics script 122. In one example, the experience analytics script 122 is hosted on the third-party server 108 with the client’s website and processed by the Internet browsing application on the customer client device 106. The experience analytics script 122 can incorporate a scripting language (e.g., a .*js file or a .json file).

In certain examples, a client’s native application (e.g., ANDROID™ or IOS™ Application) is downloaded on the customer client device 106. In this example, the client’s native application including the experience analytics script 122 is programmed in JavaScript leveraging a Software Development Kit (SDK) provided by the experience analytics server system 124. The SDK includes Application Programming Interfaces (APIs) with functions that can be called or invoked by the client’s native application.

In one example, the experience analytics script 122 records data including the changes in the interface of the website being displayed on the customer client device 106, the elements on the website being displayed or visible on the interface of the customer client device 106, the text inputs by the user into the website, a movement of a mouse (or touchpad or touch screen) cursor and mouse (or touchpad or touch screen) clicks on the interface of the website, etc. The experience analytics script 122 transmits the data to experience analytics server system 124 via the network 110. In another example, the experience analytics script 122 transmits the data to the third-party server 108 and the data can be transmitted from the third-party server 108 to the experience analytics server system 124 via the network 110.

An experience analytics client 104 is able to communicate and exchange data with the experience analytics server system 124 via the network 110. The data exchanged between the experience analytics client 104 and the experience analytics server system 124, includes functions (e.g., commands to invoke functions) as well as payload data (e.g., website data, texts reporting errors, insights, merchandising information, adaptability information, images, graphs providing visualizations of experience analytics, session replay videos, zoning and overlays to be applied on the website, etc.).

The experience analytics server system 124 supports various services and operations that are provided to the experience analytics client 104. Such operations include transmitting data to and receiving data from the experience analytics client 104. Data exchanges to and from the experience analytics server system 124 are invoked and controlled through functions available via user interfaces (UIs) of the experience analytics client 104.

The experience analytics server system 124 provides server-side functionality via the network 110 to a particular experience analytics client 104. While certain functions of the experience analytics system 100 are described herein as being performed by either an experience analytics client 104 or by the experience analytics server system 124, the location of certain functionality either within the experience analytics client 104 or the experience analytics server system 124 may be a design choice. For example, it may be technically preferable to initially deploy certain technology and functionality within the experience analytics server system 124 but to later migrate this technology and functionality to the experience analytics client 104 where a member client device 102 has sufficient processing capacity.

Turning now specifically to the experience analytics server system 124, an Application Program Interface (API) server 114 is coupled to, and provides a programmatic interface to, application servers 112. The application servers 112 are communicatively coupled to a database server 118, which facilitates access to a database 300 that stores data associated with experience analytics processed by the application servers 112. Similarly, a web server 120 is coupled to the application servers 112, and provides web-based interfaces to the application servers 112. To this end, the web server 120 processes incoming network requests over the Hypertext Transfer Protocol (HTTP) and several other related protocols.

The Application Program Interface (API) server 114 receives and transmits message data (e.g., commands and message payloads) between the member client device 102 and the application servers 112. Specifically, the Application Program Interface (API) server 114 provides a set of interfaces (e.g., routines and protocols) that can be called or queried by the experience analytics client 104 or the experience analytics script 122 in order to invoke functionality of the application servers 112. The Application Program Interface (API) server 114 exposes to the experience analytics client 104 various functions supported by the application servers 112, including generating information on errors, insights, merchandising information, adaptability information, images, graphs providing visualizations of experience analytics, session replay videos, zoning and overlays to be applied on the website, etc.

The application servers 112 host a number of server applications and subsystems, including for example an experience analytics server 116. The experience analytics server 116 implements a number of data processing technologies and functions, particularly related to the aggregation and other processing of data including the changes in the interface of the website being displayed on the customer client device 106, the elements on the website being displayed or visible on the interface of the customer client device 106, the text inputs by the user into the website, a movement of a mouse (or touchpad) cursor and mouse (or touchpad) clicks on the interface of the website, etc. received from multiple instances of the experience analytics script 122 on customer client devices 106. The experience analytics server 116 implements processing technologies and functions, related to generating user interfaces including information on errors, insights, merchandising information, adaptability information, images, graphs providing visualizations of experience analytics, session replay videos, zoning and overlays to be applied on the website, etc. Other processor and memory intensive processing of data may also be performed server-side by the experience analytics server 116, in view of the hardware requirements for such processing.

### System Architecture

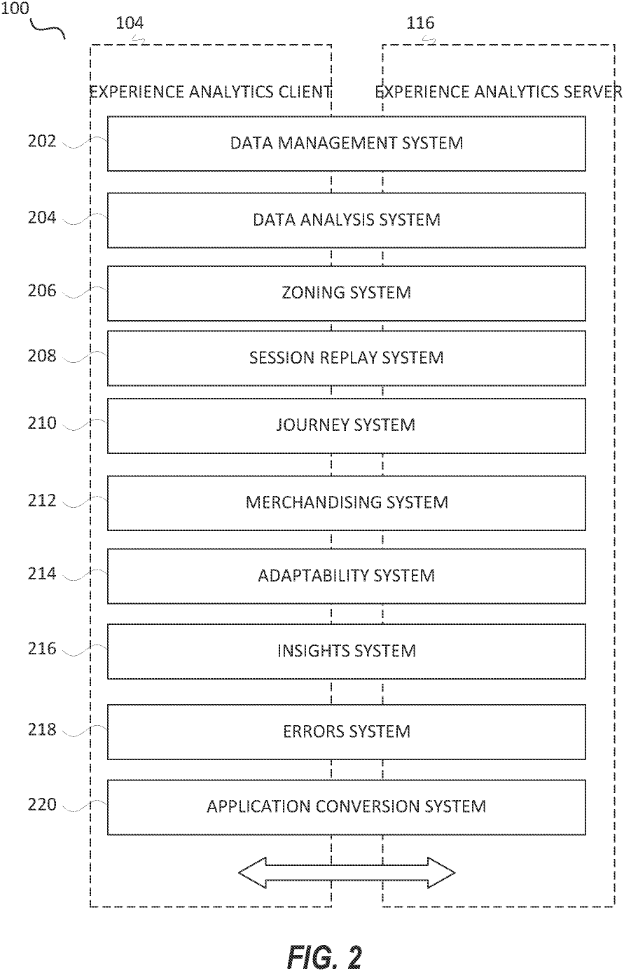

FIG. 2 is a block diagram illustrating further details regarding the experience analytics system 100 according to some examples. Specifically, the experience analytics system 100 is shown to comprise the experience analytics client 104 and the experience analytics server 116. The experience analytics system 100 embodies a number of subsystems, which are supported on the client-side by the experience analytics client 104 and on the server-side by the experience analytics server 116. These subsystems include, for example, a data management system 202, a data analysis system 204, a zoning system 206, a session replay system 208, a journey system 210, a merchandising system 212, an adaptability system 214, an insights system 216, an errors system 218, and an application conversion system 220.

The data management system 202 is responsible for receiving functions or data from the member client devices 102, the experience analytics script 122 executed by each of the customer client devices 106, and the third-party servers 108. The data management system 202 is also responsible for exporting data to the member client devices 102 or the third-party servers 108 or between the systems in the experience analytics system 100. The data management system 202 is also configured to manage the third-party integration of the functionalities of experience analytics system 100.

The data analysis system 204 is responsible for analyzing the data received by the data management system 202, generating data tags, performing data science and data engineering processes on the data.

The zoning system 206 is responsible for generating a zoning interface to be displayed by the member client device 102 via the experience analytics client 104. The zoning interface provides a visualization of how the users via the customer client devices 106 interact with each element on the client’s website. The zoning interface can also provide an aggregated view of in-page behaviors by the users via the customer client device 106 (e.g., clicks, scrolls, navigation). The zoning interface can also provide a side-by-side view of different versions of the client’s website for the client’s analysis. For example, the zoning system 206 can identify the zones in a client’s website that are associated with a particular element in displayed on the website (e.g., an icon, a text link, etc.). Each zone can be a portion of the website being displayed. The zoning interface can include a view of the client’s website. The zoning system 206 can generate an overlay including data pertaining to each of the zones to be overlaid on the view of the client’s website. The data in the overlay can include, for example, the number of views or clicks associated with each zone of the client’s website within a period of time, which can be established by the user of the member client device 102. In one example, the data can be generated using information from the data analysis system 204.

The session replay system 208 is responsible for generating the session replay interface to be displayed by the member client device 102 via the experience analytics client 104. The session replay interface includes a session replay that is a video reconstructing an individual user’s session (e.g., visitor session) on the client’s website. The user’s session starts when the user arrives at the client’s website and ends upon the user’s exit from the client’s website. A user’s session when visiting the client’s website on a customer client device 106 can be reconstructed from the data received from the user’s experience analytics script 122 on customer client devices 106. The session replay interface can also include the session replays of a number of different visitor sessions to the client’s website within a period of time (e.g., a week, a month, a quarter, etc.). The session replay interface allows the client via the member client device 102 to select and view each of the session replays. In one example, the session replay interface can also include an identification of events (e.g., failed conversions, angry customers, errors in the website, recommendations or insights) that are displayed and allow the user to navigate to the part in the session replay corresponding to the events such that the client can view and analyze the event.

The journey system 210 is responsible for generating the journey interface to be displayed by the member client device 102 via the experience analytics client 104. The journey interface includes a visualization of how the visitors progress through the client’s website, page-by-page, from entry onto the website to the exit (e.g., in a session). The journey interface can include a visualization that provides a customer journey mapping (e.g., sunburst visualization). This visualization aggregates the data from all of the visitors (e.g., users on different customer client devices 106) to the website, and illustrates the visited pages and in order in which the pages were visited. The client viewing the journey interface on the member client device 102 can identify anomalies such as looping behaviors and unexpected drop-offs. The client viewing the journey interface can also assess the reverse journeys (e.g., pages visitors viewed before arriving at a particular page). The journey interface also allows the client to select a specific segment of the visitors to be displayed in the visualization of the customer journey.

The merchandising system 212 is responsible for generating the merchandising interface to be displayed by the member client device 102 via the experience analytics client 104. The merchandising interface includes merchandising analysis that provides the client with analytics on the merchandise to be promoted on the website, optimization of sales performance, the items in the client’s product catalog on a granular level, competitor pricing, etc. The merchandising interface can, for example, comprise graphical data visualization pertaining to product opportunities, category, brand performance, etc. For instance, the merchandising interface can include the analytics on conversions (e.g., sales, revenue) associated with a placement or zone in the client website.

The adaptability system 214 is responsible for creating accessible digital experiences for the client’s website to be displayed by the customer client devices 106 for users that would benefit from an accessibility-enhanced version of the client’s website. For instance, the adaptability system 214 can improve the digital experience for users with disabilities, such as visual impairments, cognitive disorders, dyslexia, and age-related needs. The adaptability system 214 can, with proper user permissions, analyze the data from the experience analytics script 122 to determine whether an accessibility-enhanced version of the client’s website is needed, and can generate the accessibility-enhanced version of the client’s website to be displayed by the customer client device 106.

The insights system 216 is responsible for analyzing the data from the data management system 202 and the data analysis system 204 surface insights that include opportunities as well as issues that are related to the client’s website. The insights can also include alerts that notify the client of deviations from a client’s normal business metrics. The insights can be displayed by the member client devices 102 via the experience analytics client 104 on a dashboard of a user interface, as a pop-up element, as a separate panel, etc. In this example, the insights system 216 is responsible for generating an insights interface to be displayed by the member client device 102 via the experience analytics client 104. In another example, the insights can be incorporated in another interface such as the zoning interface, the session replay, the journey interface, or the merchandising interface to be displayed by the member client device 102.

The errors system 218 is responsible for analyzing the data from the data management system 202 and the data analysis system 204 to identify errors that are affecting the visitors to the client’s website and the impact of the errors on the client’s business (e.g., revenue loss). The errors can include the location within the user journey on the website and the page that adversely affects (e.g., causes frustration for) the users (e.g., users on customer client devices 106 visiting the client’s website). The errors can also include causes of looping behaviors by the users, in-page issues such as unresponsive calls to action and slow loading pages, etc. The errors can be displayed by the member client devices 102 via the experience analytics client 104 on a dashboard of a user interface, as a pop-up element, as a separate panel, etc. In this example, the errors system 218 is responsible for generating an errors interface to be displayed by the member client device 102 via the experience analytics client 104. In another example, the insights can be incorporated in another interface such as the zoning interface, the session replay, the journey interface, or the merchandising interface to be displayed by the member client device 102.

The application conversion system 220 is responsible for the conversion of the functionalities of the experience analytics server 116 as provided to a client’s website to a client’s native mobile applications. For instance, the application conversion system 220 generates the mobile application version of the zoning interface, the session replay, the journey interface, the merchandising interface, the insights interface, and the errors interface to be displayed by the member client device 102 via the experience analytics client 104. The application conversion system 220 generates an accessibility-enhanced version of the client’s mobile application to be displayed by the customer client devices 106.

The insights system 216 may provide detailed analytics information for variant products (e.g., products that differ based on size, color, finish, material, representation in an online store, packaging, flavor, texture, cover, style, filling) but which otherwise may be considered a single product. For example, a shoe brand, a light fixture, a shirt, etc., with different colors, sizes, finishes, or the like, may each correspond to a product with different variants. The data management system 202 may store information for the variants. For example, information corresponding to a SKU may be stored. A SKU may be unique to a variant. In some examples, a pageview (e.g., as captured in a URL) may not be unique to a variant, but instead unique to a product or a group of variants of a product. The data analysis system 204 may correlate SKUs to URLs to generate variant-specific information. The variant-specific information may be used by the insights system 216 to provide various insights to a user. In some examples, the insights may include average conversion rate, rankings of pageviews per variant or group of variants, cross-selling details for a particular variant or group of variants, changes between or among variants, or the like.

### Data Architecture

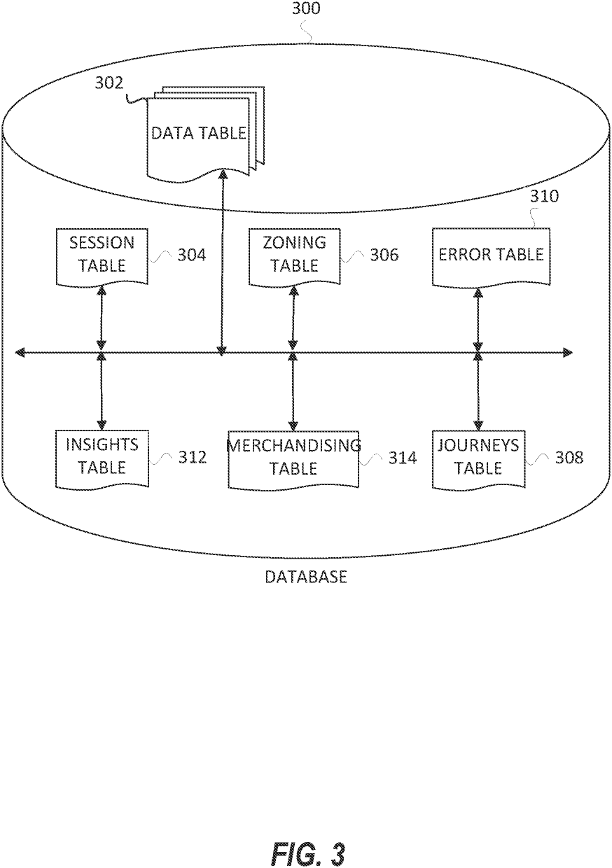

FIG. 3 is a schematic diagram illustrating database 300, which may be stored in the database 300 of the experience analytics server 116, according to certain examples. While the content of the database 300 is shown to comprise a number of tables, it will be appreciated that the data could be stored in other types of data structures (e.g., as an object-oriented database).

The database 300 includes a data table 302, a session table 304, a zoning table 306, an error table 310, an insights table 312, a merchandising table 314, and a journeys table 308.

The data table 302 stores data regarding the websites and native applications associated with the clients of the experience analytics system 100. The data table 302 can store information on the contents of the website or the native application, the changes in the interface of the website being displayed on the customer client device 106, the elements on the website being displayed or visible on the interface of the customer client device 106, the text inputs by the user into the website, a movement of a mouse (or touchpad or touch screen) cursor and mouse (or touchpad or touch screen) clicks on the interface of the website, etc. The data table 302 can also store data tags and results of data science and data engineering processes on the data. The data table 302 can also store information such as the font, the images, the videos, the native scripts in the website or applications, etc.

The session table 304 stores session replays for each of the client’s websites and native applications.

The zoning table 306 stores data related to the zoning for each of the client’s websites and native applications including the zones to be created and the zoning overlay associated with the websites and native applications.

The journeys table 308 stores data related to the journey of each visitor to the client’s website or through the native application.

The error table 310 stores data related to the errors generated by the errors system 218 and the insights table 312 stores data related to the insights generated by the insights table 312.

The merchandising table 314 stores data associated with the merchandising system 212. For example, the data in the merchandising table 314 can include the product catalog for each of the clients, information on the competitors of each of the clients, the data associated with the products on the websites and applications, the analytics on the product opportunities and the performance of the products based on the zones in the website or application, etc.

### Process

Although the described flowcharts can show operations as a sequential process, many of the operations can be performed in parallel or concurrently. In addition, the order of the operations may be re-arranged. A process is terminated when its operations are completed. A process may correspond to a method, a procedure, an algorithm, etc. The operations of methods may be performed in whole or in part, may be performed in conjunction with some or all of the operations in other methods, and may be performed by any number of different systems, such as the systems described herein, or any portion thereof, such as a processor included in any of the systems.

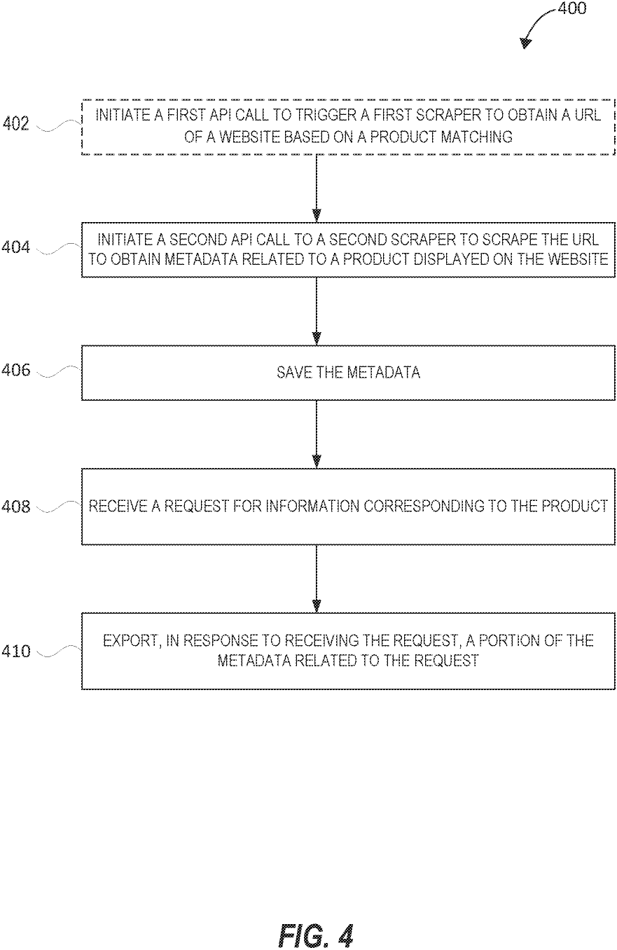

FIG. 4 is a schematic diagram illustrating a process 400 for obtaining metadata related to a product from a website. The process 400 includes an optional operation 402 to initiate a first API call to trigger a first scraper to obtain a URL of a website based on a product matching. The first scraper may find the product by mimicking someone (e.g., a user) searching a shopping website (e.g., the website discussed below). In an example, error management may occur, such as after one or more operations of the process 400, (e.g., a retry before raising an alert to a team managing an operation).

The process 400 includes an operation 404 to initiate a second API call to a second scraper to scrape the URL to obtain metadata related to a product displayed on the website. In an example, the first API call triggers the first scraper to obtain a plurality of URLs. In this example, initiating the second API call may include initiating the second API call to a plurality of scrapers. The metadata obtained may be received from the plurality of URLs via the plurality of scrapers. The second API call may identify the URL, in some examples.

The process 400 includes an operation 406 to save the metadata, for example to a database. The process 400 includes an operation 408 to receive a request for information corresponding to the product. Operation 408 may occur before initiating the second API call in some examples. In other examples, operation 408 occurs after the second API call has been initiated. In these other examples, operation 408 may occur after the second API call has been initiated a plurality of times (e.g., to gather a set of metadata). The request for information may be received based on a schedule (e.g., hourly, daily, weekly, monthly, etc.). In an example, two or more API calls may be chained. For example, after operation 406, a third API call to a scraper may be requested, scraped data may be saved, and another scraper may be called subsequently, etc.

The process 400 includes an operation 410 to export (e.g., from the database), in response to receiving the request, a portion of the metadata related to the request. The portion of the metadata related to the request may include one or more attributes of the product on the website, such as competitor price information, discount information, product display location, etc.

The process 400 may include saving the URL to the database after the first scraper has obtained the URL. In some examples, the process 400 includes identifying the product before the first API call. The process 400 may include cleaning the database, for example by removing deprecated data, setting an inactive flag, or the like.

### Machine Architecture

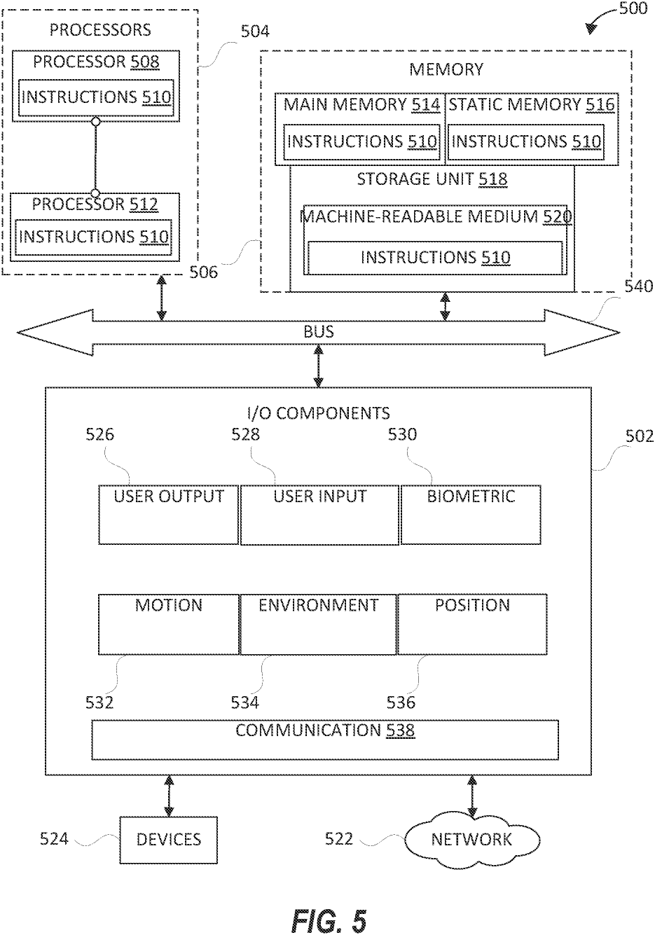

FIG. 5 is a diagrammatic representation of the machine 500 within which instructions 510 (e.g., software, a program, an application, an applet, an application, or other executable code) for causing the machine 500 to perform any one or more of the methodologies discussed herein may be executed. For example, the instructions 510 may cause the machine 500 to execute any one or more of the methods described herein. The instructions 510 transform the general, non-programmed machine 500 into a particular machine 500 programmed to carry out the described and illustrated functions in the manner described. The machine 500 may operate as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 510, sequentially or otherwise, that specify actions to be taken by the machine 500. Further, while only a single machine 500 is illustrated, the term “machine” shall also be taken to include a collection of machines that individually or jointly execute the instructions 510 to perform any one or more of the methodologies discussed herein. The machine 500, for example, may comprise the member client device 102 or any one of a number of server devices forming part of the experience analytics server 116. In some examples, the machine 500 may also comprise both client and server systems, with certain operations of a particular method or algorithm being performed on the server-side and with certain operations of the particular method or algorithm being performed on the client-side.

The machine 500 may include processors 504, memory 506, and input/output I/O components 502, which may be configured to communicate with each other via a bus 540. In an example, the processors 504 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 508 and a processor 512 that execute the instructions 510. The term “processor” is intended to include multi-core processors that may comprise two or more independent processors (sometimes referred to as “cores”) that may execute instructions contemporaneously. Although FIG. 5 shows multiple processors 504, the machine 500 may include a single processor with a single-core, a single processor with multiple cores (e.g., a multi-core processor), multiple processors with a single core, multiple processors with multiples cores, or any combination thereof.

The memory 506 includes a main memory 514, a static memory 516, and a storage unit 518, both accessible to the processors 504 via the bus 540. The main memory 506, the static memory 516, and storage unit 518 store the instructions 510 embodying any one or more of the methodologies or functions described herein. The instructions 510 may also reside, completely or partially, within the main memory 514, within the static memory 516, within machine-readable medium 520 within the storage unit 518, within at least one of the processors 504 (e.g., within the processor’s cache memory), or any suitable combination thereof, during execution thereof by the machine 500.

The I/O components 502 may include a wide variety of components to receive input, provide output, produce output, transmit information, exchange information, capture measurements, and so on. The specific I/O components 502 that are included in a particular machine will depend on the type of machine. For example, portable machines such as mobile phones may include a touch input device or other such input mechanisms, while a headless server machine will likely not include such a touch input device. It will be appreciated that the I/O components 502 may include many other components that are not shown in FIG. 5. In various examples, the I/O components 502 may include user output components 526 and user input components 528. The user output components 526 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 528 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 502 may include biometric components 530, motion components 532, environmental components 534, or position components 536, among a wide array of other components. For example, the biometric components 530 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 532 include acceleration sensor components (e.g., accelerometer), gravitation sensor components, rotation sensor components (e.g., gyroscope).

The environmental components 534 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the member client device 102 may have a camera system comprising, for example, front cameras on a front surface of the member client device 102 and rear cameras on a rear surface of the member client device 102. The front cameras may, for example, be used to capture still images and video of a user of the member client device 102 (e.g., “selfies”). The rear cameras may, for example, be used to capture still images and videos in a more traditional camera mode. In addition to front and rear cameras, the member client device 102 may also include a 360° camera for capturing 360° photographs and videos.

Further, the camera system of a member client device 102 may include dual rear cameras (e.g., a primary camera as well as a depth-sensing camera), or even triple, quad or penta rear camera configurations on the front and rear sides of the member client device 102. These multiple cameras systems may include a wide camera, an ultra-wide camera, a telephoto camera, a macro camera and a depth sensor, for example.

The position components 536 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 502 further include communication components 538 operable to couple the machine 500 to a network 522 or devices 524 via respective coupling or connections. For example, the communication components 538 may include a network interface component or another suitable device to interface with the network 522. In further examples, the communication components 538 may include wired communication components, wireless communication components, cellular communication components, Near Field Communication (NFC) components, Bluetooth^{®} components (e.g., Bluetooth^{®} Low Energy), Wi-Fi^{®} components, and other communication components to provide communication via other modalities. The devices 524 may be another machine or any of a wide variety of peripheral devices (e.g., a peripheral device coupled via a USB).

Moreover, the communication components 538 may detect identifiers or include components operable to detect identifiers. For example, the communication components 538 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 538, such as location via Internet Protocol (IP) geolocation, location via Wi-Fi® signal triangulation, location via detecting an NFC beacon signal that may indicate a particular location, and so forth.

The various memories (e.g., main memory 514, static memory 516, and memory of the processors 504) and storage unit 518 may store one or more sets of instructions and data structures (e.g., software) embodying or used by any one or more of the methodologies or functions described herein. These instructions (e.g., the instructions 510), when executed by processors 504, cause various operations to implement the disclosed examples.

The instructions 510 may be transmitted or received over the network 522, using a transmission medium, via a network interface device (e.g., a network interface component included in the communication components 538) and using any one of several well-known transfer protocols (e.g., hypertext transfer protocol (HTTP)). Similarly, the instructions 510 may be transmitted or received using a transmission medium via a coupling (e.g., a peer-to-peer coupling) to the devices 524.

### Software Architecture

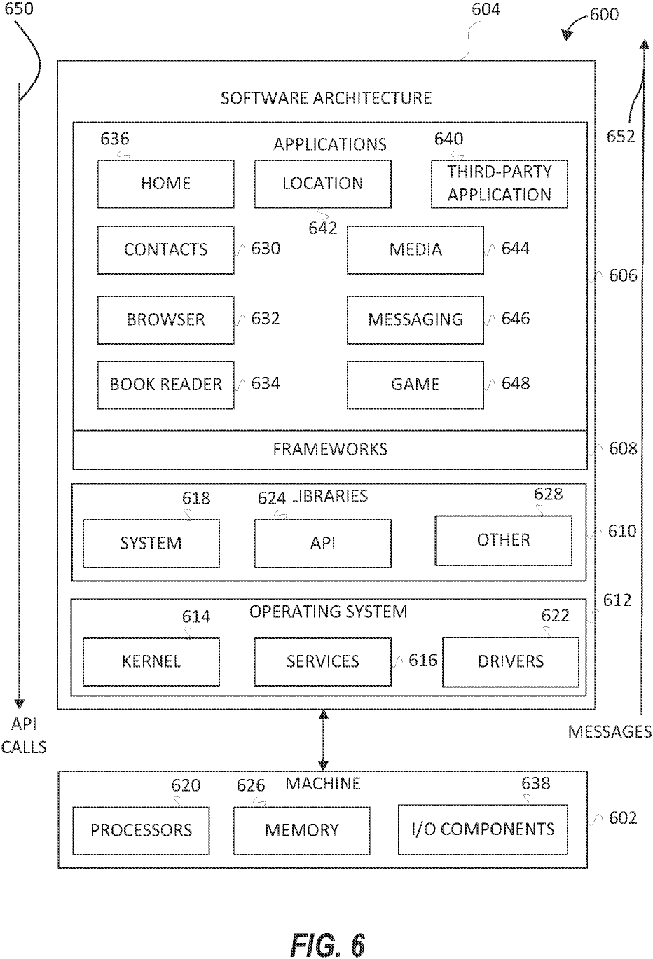

FIG. 6 is a block diagram 600 illustrating a software architecture 604, which can be installed on any one or more of the devices described herein. The software architecture 604 is supported by hardware such as a machine 602 that includes processors 620, memory 626, and I/O components 638. In this example, the software architecture 604 can be conceptualized as a stack of layers, where each layer provides a particular functionality. The software architecture 604 includes layers such as an operating system 612, libraries 610, frameworks 608, and applications 606. Operationally, the applications 606 invoke API calls 650 through the software stack and receive messages 652 in response to the API calls 650.

The operating system 612 manages hardware resources and provides common services. The operating system 612 includes, for example, a kernel 614, services 616, and drivers 622. The kernel 614 acts as an abstraction layer between the hardware and the other software layers. For example, the kernel 614 provides memory management, processor management (e.g., scheduling), component management, networking, and security settings, among other functionalities. The services 616 can provide other common services for the other software layers. The drivers 622 are responsible for controlling or interfacing with the underlying hardware. For instance, the drivers 622 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 610 provide a common low-level infrastructure used by the applications 606. The libraries 610 can include system libraries 618 (e.g., C standard library) that provide functions such as memory allocation functions, string manipulation functions, mathematic functions, and the like. In addition, the libraries 610 can include API libraries 624 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 610 can also include a wide variety of other libraries 628 to provide many other APIs to the applications 606.

The frameworks 608 provide a common high-level infrastructure that is used by the applications 606. For example, the frameworks 608 provide various graphical user interface (GUI) functions, high-level resource management, and high-level location services. The frameworks 608 can provide a broad spectrum of other APIs that can be used by the applications 606, some of which may be specific to a particular operating system or platform.

In an example, the applications 606 may include a home application 636, a contacts application 630, a browser application 632, a book reader application 634, a location application 642, a media application 644, a messaging application 646, a game application 648, and a broad assortment of other applications such as a third-party application 640. The applications 606 are programs that execute functions defined in the programs. Various programming languages can be employed to create one or more of the applications 606, structured in a variety of manners, such as object-oriented programming languages (e.g., Objective-C, Java, or C++) or procedural programming languages (e.g., C or assembly language). In a specific example, the third-party application 640 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 640 can invoke the API calls 650 provided by the operating system 612 to facilitate functionality described herein.

### User Interfaces for Presenting a Website

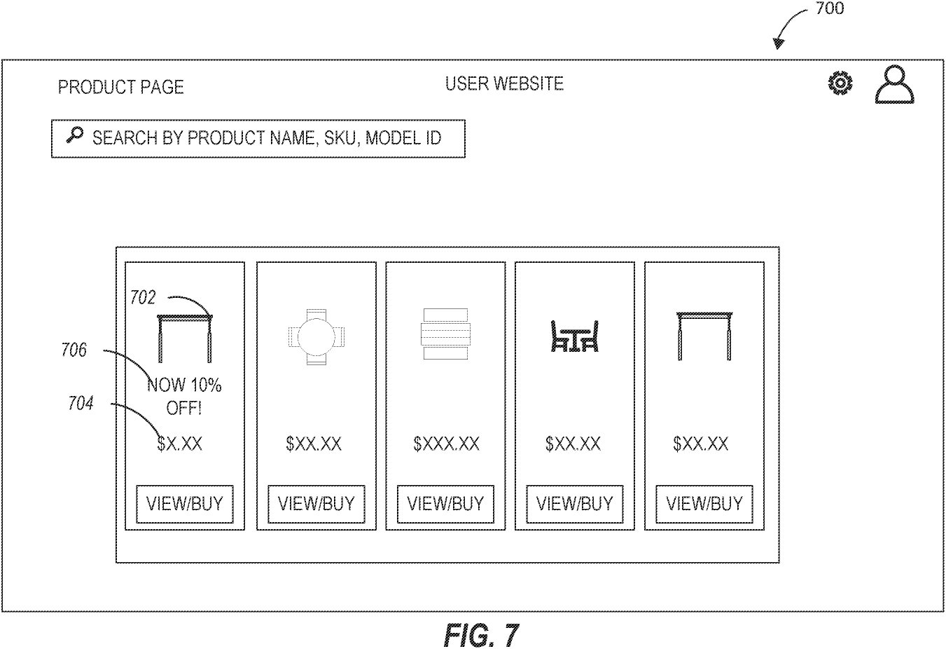

FIG. 7 illustrates an example user website 700 including a product 702. The product 702 may be associated with metadata, such as a price 704 or a discount 706. The example user website 700 may include a website for purchasing the product 702, such as a merchant website, a marketplace website, etc. The example user website 700 may include a plurality of products. The example user website 700 may be accessed publicly (e.g., via the internet). The example user website 700 may be a website accessed by a scraper, as described herein. In an example, the scraper may be used to determine that the product 702, which may be predetermined (e.g., selected by a client via a user interface or list) is on the example user website 700. In some examples, a scraper may mimic a user accessing the example user website 700 to identify metadata about the product 702, such as the price 704 or the discount 706. This example scraper may access the example user website 700 more than once.

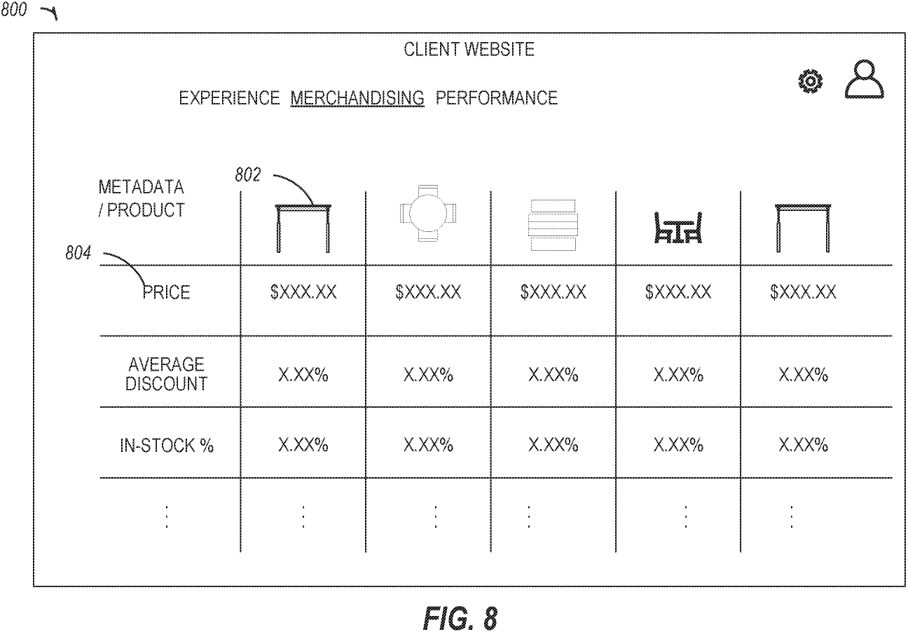

FIG. 8 illustrates an example client website 800, in accordance with some examples. The example client website 800 may be a private website (e.g., one that is not publicly accessible, such as requiring a client to login, etc.). The example client website 800 illustrates various products (e.g., ones selected by a client, searched, filtered, or the like), such as a product 802. The example client website 800 includes metadata regarding the products, such as a price 804. The metadata may be pulled from a database or other storage location periodically or on demand (e.g., when the example client website 800 is accessed, when a client logs in, etc.). A single product (e.g., product 802) or multiple products may be displayed on the example client website 800. In some examples, the metadata displayed may include a single type (e.g., price 804), while in other examples multiple types of metadata may be displayed (e.g., price, percent of times a product was in stock when accessed by a scraper over a time period, or the like).

The price metadata 804 may include captured price data, such as a minimum price, a maximum price, a range of prices, a most frequently displayed price, an average price, a median price, a price differential (e.g., as compared to a client selected or identified price, such as a price on a client’s website), or the like. In some examples, a client may select a product or metadata type to view additional information about the product or the metadata type. The example client website 800 may be refreshed, for example when a scraper adds new information retrieved from a user website (e.g., website 700 of FIG. 7), when a database is updated (e.g., cleaned, such as by removing old or incorrect data), in response to a client request, in response to an updated list of products, or the like. In some examples, the example client website 800 may indicate one or more URLs corresponding to the product 802 (e.g., a URL for a website such as website 700 where the metadata was obtained).

The example client website 800 may be customized. For example, a client may select which metadata types to display, how many or which products to display, how the information is to be filtered or sorted, or the like. The metadata shown in the example client website 800 may correspond to a time period (e.g., price over a previous ten or fourteen days, over a previous month, etc.). The time period may be selected by a client or may be determined automatically (e.g., by number of days, by number of times a scraper has run or captured metadata, or the like). In some examples, the example client website 800 may show metadata related to a product (e.g., product 804) over time (e.g., average price over time).

### Flow Diagrams

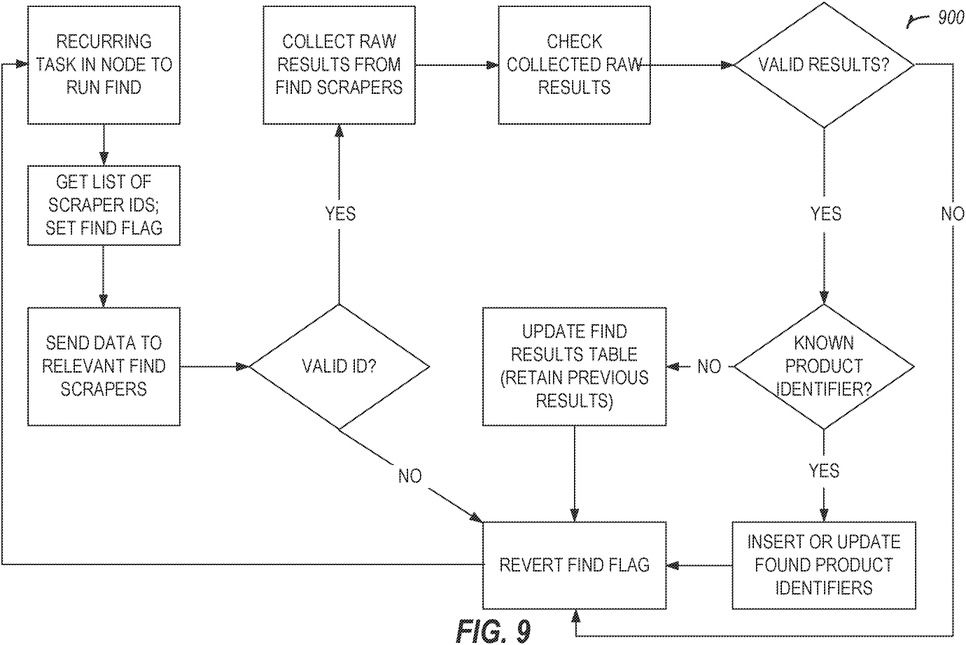

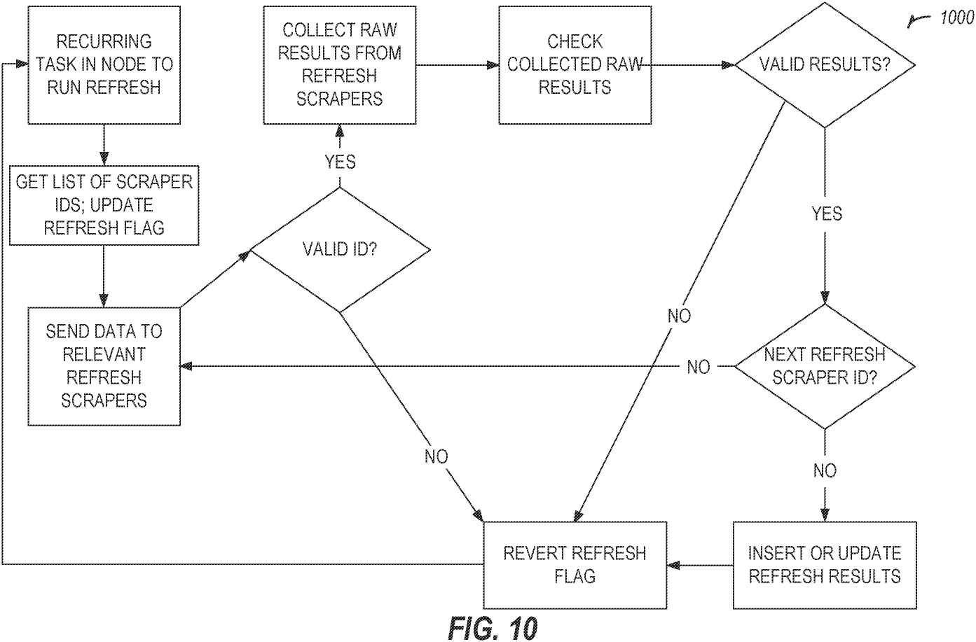

FIGS. 9–10 illustrate example flow diagrams, in accordance with some examples. The flow diagrams of FIGS. 9-10 represent workflows, but are not intended to require each step. For example, in a repeat of a workflow, certain aspects maybe omitted. The workflows may be initiated by an input (e.g., as part of an initiation workflow), based on a schedule, periodically, or the like. The multiple workflows described herein may handle collection or export of competitive data related to one or more products. The workflows may run asynchronously or concurrently. FIG. 9 illustrates a “find” workflow, which may include recurring or single tasks, such as obtaining a list of products to be found, triggering jobs from relevant find scrapers, or storing find results. FIG. 10 illustrates a “refresh” workflow, which may include recurring or single tasks, such as obtaining a list of products to be refreshed, triggering jobs from relevant refresh scrapers, or storing refresh results. Other workflows not shown, but described may include an “export” workflow to schedule or generate a competitive data export (e.g., for display, such as a on a client website), a “cleanup” workflow, for example to clean tables in a storage medium (e.g., a database), or the like.

FIG. 9 illustrates a find workflow 900 for finding correct associations with competitive offers, for example based on an identifier (e.g., a GTIN). The find workflow 900 may use a market provided by a requester (e.g., a client requesting the data), for example on different sources. An association may be identified when a product identifier is found by searching an identifier (e.g., a GTIN) on a source. Find scrapers may be used on individual website, shopping websites (e.g., aggregators or marketplaces), or the like. In an example, a product identifier may be specific to the website scraped. In some examples, the find workflow 900 may be triggered multiple times from a single identifier or market. New find scrapers may be added as needed or requested. A scraping configuration from a requester may indicate which scrapers are to be used.

The find workflow 900 of FIG. 9 includes, after initialization, operations to obtain products to find, send data to find scrapers, collect results from find scrapers, validate the collected results, and insert or update (e.g., upsert) the validated data. More detail regarding the operations of the workflow 900 is provided below.

The workflow 900 may include obtaining products to find. This operation identifies the products to be processed in the find pipeline. Requesters may have a different find rate (e.g., a monthly refresh, a weekly refresh, etc.). The list of products to be found may take this rate into account. One or more parameters may be specified to a scraper, such as identifier of a product, market (e.g., France, Europe, North America, New York State, New York City, etc), language, currency, or the like. A scraper identifier may be used to identify which scraper to initiate. The scraper identifier, and optionally one or more of the above parameters), may be provided by a client requesting the find. In some examples, when more than one client requests information for a same identifier and market, a single find may be done, to satisfy the multiple requests (subject to the find rates of each).

After the information is gathered, it may be sent to one or more scrapers (e.g., based on a scraper identifier). The list of products to be found may be grouped by scraper identifier. Each group may be divided into multiple batches according to a setting in configuration, for example to limit the size of batches. A chained task may be submitted for each batch. The chained task may allow flow control over the different operations of the workflow 900 (e.g., go to next step in case of success, retry or error callback in case of errors). Each chained task may be processed concurrently and without interact with other chained tasks.

Data needed to start the scraping job may be sent to the relevant scraper using the scraper identifier Each chained task may receive a collection identifier used to identify the scraping job and collect the scraped data in the next step. FIG. 9 illustrates a decision point in the workflow 900, where, when the identifier is valid (e.g., for a scraper identifier, a product identifier, or a collection identifier), results from are collected from the scraper. When the identifier is invalid, a find flag (e.g., set in the initialization operation to true) may be reverted (e.g., to false).

The results collected from the scraper may be raw product identifiers based on the collection identifier provided in previous step. In some examples, a delay may occur before the data is ready from scraper side. The raw data may be validated as collected results. Validating the raw data includes analyzing the results collected to check whether data is compliant with a scraper API contract. In this operation, unreliable results may be removed. For invalid results, a task to disable the find running flag for the concerned product may be created. When the results are invalid, the find flag (e.g., set in the initialization operation to true) may be reverted (e.g., to false). In some examples, a product without valid results may be found again in the next find workflow 900.

Validated data may be compared to a list of product identifiers (e.g., product identifiers for products to be scraped in this find workflow 900 or in the collection identifier). When data for a product is not found, the find results table may be updated or previous results may be retained (e.g., an update may be made to the find timestamp for the product). When a corresponding product is found, the validated data may be output to storage (e.g., a table, a database, etc.). The validated data may be stored while accumulating a set of results. In some examples, the validated data may be output for display on a website. The validated data may be used to insert or update (e.g., upsert) a stored data object (e.g., a table, a database, etc.). When a corresponding product identifier is found, the result may be upserted in a find results portion of the data object using an SQL query. After updating or storing the validated data, the find workflow 900 may include setting the flag back to false to ready the find workflow 900 for another iteration when needed.

FIG. 10 illustrates a refresh workflow 1000 for obtaining metadata related to a product. The metadata may be obtained by scraping a website that includes the product, such as a website having a corresponding URL that was identified using the find workflow 900. The refresh workflow 1000 may be run as a recurring task, such as on demand, according to a schedule, based on a time between last running, based on a number of pending tasks, or the like.

The refresh workflow 1000 may use the product identifiers and URLs found in the find workflow 900 in some examples to obtain product metadata. A scraper may be used to collect data from a marketplace or website. A set of scrapers may be used, which may be modified, such as adding a new scraper, editing a scraping configuration, or removing a scraper at any instance of the refresh workflow 1000. A scraper may be used to obtain metadata such as price, shipping price, reseller name, product name, reseller’s URL, offer’s URL, whether a product is in or out of stock, or the like.

The refresh workflow 1000 is divided into operations, which may be initiated after the refresh workflow 1000 is triggered. The refresh workflow 1000 includes an operation to obtain a list of products to refresh, and a flag may be set to true. After obtaining the list of products, the refresh workflow 1000 may include sending a batch of products to a scraper. Multiple batches may be sent to one or more scrapers (e.g., a set of scrapers), in some examples. The results of the scraping may be collected, validated, and stored. These operations are described in more detail below.

The refresh workflow 1000 operation to obtain a product or list of products to refresh may be received via a request. A requester may specify a refresh rate (e.g., a daily refresh, a weekly refresh, etc.) with a generated list of products to be refreshed. The refresh workflow 1000 does not require the request to be made each time the refresh workflow 1000 is performed. The refresh workflow 1000 may be iterated a specified number of times, over a period of time, indefinitely, or once. In an example, a product’s refresh may be characterized by a product identifier (e.g., a GTIN), a URL, a market, or a scraper identifier. A single product may trigger multiple refreshes with different scrapers depending on the URL found during the find workflow 900 for example, or based on a configuration identified by a requestor. To obtain a list of products, an SQL query may be performed. The query may set a refresh running flag to true in order to avoid stacking multiple refresh task on the same characterization set (e.g., same product identifier, market, URL, and scraper identifier).

The refresh workflow 1000 may include sending the data (eg., the characterization set) to a refresh scraper. This may include an API call to the refresh scraper. An extracted list of products may be grouped by refresh scraper identifier and batched into one or more requests according to a setting in configuration, for example to limit the size of batches. Like the find workflow 900, multiple chained tasks may occur in the refresh workflow 1000. Each chained task may be processed concurrently, such as without interacting with each other. Data needed to start the scraping job is sent to the relevant scraper based on the refresh scraper identifier. Each chained task may receive a collection identifier used to identify the scraping job and collect the scraped data in a future operation.

When valid identifiers are found, the refresh workflow 1000 may include collecting results from scrapers. This operation includes collecting raw product metadata from scrapers according to the collection identifier provided in a previous operation. In some examples, a delay may occur before the data is ready from scraper. The raw data may be checked, and validated. Validation may include analyzing the results collected and checking whether the data is compliant with an API contract for each scraper. Unreliable results may be removed, such as negative prices, missing reseller name, or the like. When results are not compliant, a task to disable the refresh running flag for the concerned products may be created. These products may be refreshed again in the next refresh workflow iteration based on that flag.

For validated data, the refresh workflow 1000 includes a decision operation to determine whether a next refresh scraper identifier is specified in the collected results. When there is another refresh scraper, more data may be collected with another scraper. The results may be grouped by the next refresh scraper identifier, and a task may be sent for each group. A collection identifier is provided by the scraper and the previous operation may be iterated with this new collection identifier.

Validated results may be inserted or updated (e.g., upserted) in storage. For example, validated results may be upserted. An operation to process the collected data may upsert in a refresh results table based on a query. In an example, another query may be executed in the same transaction to disable the refresh running flag to notify that the refresh is done for the products in the concerned batch.

An export workflow (not shown) may be used to export competitive data requested by a requester according to export settings. The export settings may specify frequency of export, destination for the data, etc. The export workflow may run on a periodic basis or on demand. The export workflow includes scheduling an export and generating an export. When a scheduled task to generate an export is triggered, data may be extracted from the refresh results (e.g., resulting from refresh workflow 1000) using an SQL query. The result of the query may be pushed to a cloud provider, sent to an email address, saved in a location, or the like, according to the export settings. Information corresponding to the export, such as the data and time, filename, etc., may be updated in storage. Export of competitive data may include a custom export, for example using scraping configuration management. A cleanup workflow may be used to clean old export requests, such as those saved in a table. The cleanup workflow may delete or disable old reseller offers, clear flags, or the like.

### Schematic Diagram

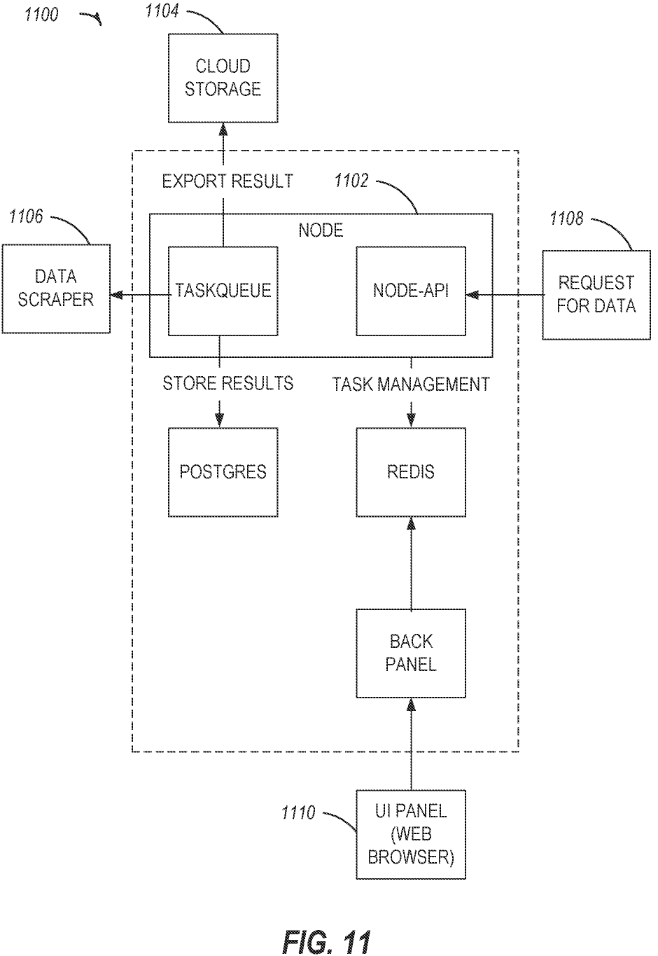

FIG. 11 illustrates an example schematic diagram 1100, in accordance with some examples. The example schematic diagram 1100 shows a New Offsite Data Engine (NODE) 1102, which communicates with cloud storage 1104, a data scraper 1106, and a data request component 1108. The NODE 1102 includes a task queue component and an API component. The NODE 1102 may receive a request for a find or refresh workflow from the data request component 1108. The NODE 1102 may communicate (e.g., using the API component) with the data scraper 1106 to obtain the requested metadata. The NODE 1102 may export results from the data scraper 1106 to the cloud storage 1104 or elsewhere (e.g., saved to a database). Results may be stored by the NODE 1102. The NODE 1102 may manage tasks (e.g., via the task queue component) and receive information via a user interface 1110.

The task queue and API components of the NODE 1102 may rely on some resources for storage (e.g., postgres & redis). The user interface 1110 may be used for monitoring purposes. The NODE 1102 may be used across regions. The NODE 1102 may perform a regular export or a custom export. The NODE 1102 includes a fail safe via an automatic retry or error management. The NODE 1102 may provide competitive data mutualization across export requests.

In some examples, the NODE 1102 may use a postgresql database to store various data such as export settings for each requester, the global identifier or market of products to obtain competitive data, identifiers of available find scrapers, identifiers of available refresh scrapers, scraping configurations, find results (e.g., URL and product identifiers) from find scrapers, refresh results from refresh scrapers, or the like.

The API of the NODE 1102 may be a service available to external consumers, allowing requests of competitive data. These requests may be processed so that the task queue may collect relevant competitive data. The API may be used to receive a request for new competitive data export or receive a request to retrieve last competitive data export. These operations may be used to provide request settings (e.g., from the data request component 1108), receive a request for current or new metadata, or the like. The API may communicate with the data scraper 1106 (which may include a plurality of data scrapers) to initiate a find or refresh action. Results may be saved and exported (e.g., to the cloud storage 1104), for example according to the request settings provided from the data request component 1108.

### Glossary

“Carrier signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

“Client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component″ (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors 1004 or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

Example 1 is a method comprising: initiating a first API call to trigger a first scraper to obtain a URL of a website based on a product matching for a product; initiating a second API call to trigger a second scraper to scrape the URL to obtain metadata related to the product displayed on the website; saving the metadata to a database; receiving a request for information corresponding to the product; and exporting from the database, in response to receiving the request, a portion of the metadata related to the request.

In Example 2, the subject matter of Example 1 includes, wherein the portion of the metadata related to the request includes competitor price information for the product.

In Example 3, the subject matter of Examples 1-2 includes, saving the URL to the database after the first scraper has obtained the URL.

In Example 4, the subject matter of Examples 1-3 includes, wherein receiving the request occurs before initiating the second API call.

In Example 5, the subject matter of Examples 1-4 includes, wherein receiving the request occurs after the second API call has been initiated a plurality of times.

In Example 6, the subject matter of Examples 1-5 includes, wherein the first API call triggers the first scraper to obtain a plurality of URLs, wherein initiating the second API call includes initiating the second API call to a plurality of scrapers, and wherein the metadata is received from the plurality of URLs via the plurality of scrapers.

In Example 7, the subject matter of Examples 1-6 includes, identifying the product before the first API call.

In Example 8, the subject matter of Examples 1-7 includes, cleaning the database by removing deprecated data or setting an inactive flag.

In Example 9, the subject matter of Examples 1-8 includes, wherein the first scraper is to find the product by mimicking someone searching a shopping website.

In Example 10, the subject matter of Examples 1-9 includes, wherein the request for information is received based on a schedule.

In Example 11, the subject matter of Examples 1-10 includes, wherein the second API call identifies the URL.

Example 12 is a computing apparatus, the computing apparatus comprising: a processor; and a memory storing instructions that, when executed by the processor, configure the apparatus to: initiate a first API call to trigger a first scraper to obtain a URL of a website based on a product matching for a product; initiate a second API call to trigger a second scraper to scrape the URL to obtain metadata related to the product displayed on the website; save the metadata to a database; receive a request for information corresponding to the product; and export from the database, in response to receiving the request, a portion of the metadata related to the request.

In Example 13, the subject matter of Example 12 includes, wherein the portion of the metadata related to the request includes competitor price information for the product.

In Example 14, the subject matter of Examples 12-13 includes, wherein the instructions further configure the apparatus to save the URL to the database after the first scraper has obtained the URL.

In Example 15, the subject matter of Examples 12-14 includes, wherein the request is received before the second API call is initiated.

In Example 16, the subject matter of Examples 12-15 includes, wherein the request is received after the second API call has been initiated a plurality of times.

In Example 17, the subject matter of Examples 12-16 includes, wherein the first API call triggers the first scraper to obtain a plurality of URLs, wherein the second API call is initiated to trigger a plurality of scrapers to scrape the plurality of URLs, and wherein the metadata is received from the plurality of URLs via the plurality of scrapers.

In Example 18, the subject matter of Examples 12-17 includes, wherein the instructions further configure the apparatus to identify the product before the first API call.

Example 19 is at least one non-transitory machine-readable medium including instructions, which when executed by processing circuitry, causes the processing circuitry to perform operations to: initiate a first API call to trigger a first scraper to obtain a URL of a website based on a product matching for a product; initiate a second API call to trigger a second scraper to scrape the URL to obtain metadata related to the product displayed on the website; save the metadata to a database; receive a request for information corresponding to the product; and export from the database, in response to receiving the request, a portion of the metadata related to the request.

In Example 20, the subject matter of Example 19 includes, wherein the first scraper is to find the product by mimicking someone searching a shopping website.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. A method comprising:
initiating a first application programming interface (API) call to trigger a first scraper to scrape a set of websites to identify at least one Uniform Resource Locator (URL) of a website that is publicly accessible, from the set of websites, based on a product matching for a product;
initiating a second API call to trigger a second scraper to scrape the website located via the previously identified URL to obtain metadata related to the product displayed on the website;
saving the metadata to a first database and the previously identified URL to a second database;
receiving a request for information corresponding to the product;
in response to receiving the request, accessing the second database to retrieve the URL corresponding to the product;
initiating the second API call to trigger the second scraper to rescrape the website located via the previously identified URL retrieved from the second database to obtain updated metadata related to the product displayed on the website;
updating the first database with the updated metadata; and
exporting from the first database, in response to receiving the request, a portion of the updated metadata related to the request.

2. The method of claim 1, wherein the portion of the metadata related to the request includes competitor price information for the product.

3. (canceled)

4. The method of claim 1, wherein receiving the request occurs before initiating the second API call.

5. The method of claim 1, wherein receiving the request occurs after the second API call has been initiated a plurality of times.

6. The method of claim 1, wherein the first API call triggers the first scraper to identify a plurality of URLs, wherein initiating the second API call includes initiating the second API call to a plurality of scrapers, and wherein the metadata is received from the plurality of URLs via the plurality of scrapers.

7. The method of claim 1, further comprising identifying the product before the first API call.

8. The method of claim 1, further comprising cleaning the first database by removing deprecated data or setting an inactive flag.

9. The method of claim 1, wherein the first scraper is to find the product by mimicking someone searching a shopping website.

10. The method of claim 1, wherein the request for information is received based on a schedule.

11. The method of claim 1, wherein the second API call identifies the URL.

12. A computing apparatus, the computing apparatus comprising:
a processor; and
a memory storing instructions that, when executed by the processor, configure the apparatus to:
initiate a first application programming interface (API) call to trigger a first scraper to scrape a set of websites to identify at least one Uniform Resource Locator (URL) of a website that is publicly accessible, from the set of websites, based on a product matching for a product;
initiate a second API call to trigger a second scraper to scrape the website located via the previously identified URL to obtain metadata related to the product displayed on the website;
save the metadata to a first database and the previously identified URL to a second database;
receive a request for information corresponding to the product;
in response to receiving the request, access the second database to retrieve the URL corresponding to the product;
initiate the second API call to trigger the second scraper to rescrape the website located via the previously identified URL retrieved from the second database to obtain updated metadata related to the product displayed on the website;
update the first database with the updated metadata; and
export from the first database, in response to receiving the request, a portion of the metadata related to the request.

13. The computing apparatus of claim 12, wherein the portion of the metadata related to the request includes competitor price information for the product.

14. (canceled)

15. The computing apparatus of claim 12, wherein the request is received before the second API call is initiated.

16. The computing apparatus of claim 12, wherein the request is received after the second API call has been initiated a plurality of times.

17. The computing apparatus of claim 12, wherein the first API call triggers the first scraper to identify a plurality of URLs, wherein the second API call is initiated to trigger a plurality of scrapers to scrape the plurality of identified URLs, and wherein the metadata is received from the plurality of URLs via the plurality of scrapers.

18. The computing apparatus of claim 12, wherein the instructions further configure the apparatus to identify the product before the first API call.

19. At least one non-transitory machine-readable medium including instructions, which when executed by processing circuitry, causes the processing circuitry to perform operations to:
initiate a first application programming interface (API) call to trigger a first scraper to scrape a set of websites to identify at least one Uniform Resource Locator (URL) of a website that is publicly accessible, from the set of websites, based on a product matching for a product;
initiate a second API call to trigger a second scraper to scrape the website located via the previously identified URL to obtain metadata related to the product displayed on the website;
save the metadata to a first database and the previously identified URL to a second database;
receive a request for information corresponding to the product;
in response to receiving the request, access the second database to retrieve the URL corresponding to the product;
initiate the second API call to trigger the second scraper to rescrape the website located via the previously identified URL retrieved from the second database to obtain updated metadata related to the product displayed on the website;
update the first database with the updated metadata; and
export from the first database, in response to receiving the request, a portion of the metadata related to the request.

20. The at least one machine-readable medium of claim 19, wherein the first scraper is to find the product by mimicking someone searching a shopping website.
